(19) United States
(12) Patent Application Publication
(10) Pub. No.: US 2024/0149199 A1
(43) Pub. Date: May 9, 2024

(54) Air purification device with optimized air guidance

(71) Applicant: IQAir AG, Steinach (CH)

(72) Inventors: Gregory GOTTSCHALK, Uster (CH); Frank HAMMES, Horn (CH); Rainer TEUCHER, Rorschacherberg (CH)

(21) Appl. No.: 18/500,248

(22) Filed: Nov. 2, 2023

(30) Foreign Application Priority Data
Nov. 2, 2022 (EP) 22204994.2

(51) Int. Cl. B01D 46/00; B01D 46/52; F24F 8/108

(52) U.S. Cl. CPC B01D 46/0049; B01D 46/525; F24F 8/108; B01D 2273/30

(57) ABSTRACT

An air purification device with air guidance, including a housing, including an air intake region, formed in an inlet plenum, for drawing dirty air into the housing, and an air discharge region, formed in an outlet plenum, for discharging filtered air from the housing, a fan impeller of a radial ventilator that is rotatable about a ventilator rotational axis and an air filter for filtering the air drawn in through the air intake region being situated in the housing, the main nozzle air flow formed downstream from the air filter being deflected in the direction of the fan impeller at a main nozzle situated in the housing, upstream from the fan impeller. The main nozzle air flow is split by an auxiliary nozzle that is situated upstream from the main nozzle, and the auxiliary nozzle supplies an auxiliary nozzle air flow into the inner intake region of the fan impeller.

The invention relates to an air purifier/ventilator with optimized air guidance. An air purifier of the same species has become known from the subject matter of EP 3 457 047 A1 by the present applicant.

Cited EP 3 457 047 A1 describes an air purification device comprising a housing, including at least one air intake region, formed in an inlet plenum, for drawing dirty air into the housing, and at least one air discharge region, formed in an outlet plenum, for discharging the filtered air from the housing. At least one fan impeller of a radial ventilator that is rotatable about a ventilator rotational axis and at least one intake air filter for filtering the air drawn in through the air intake region are situated in the housing. A radial main nozzle air flow that is formed downstream from the air filter is deflected in the axial direction onto the fan impeller at a main nozzle situated in the housing, upstream from the fan impeller.

However, in cited EP 3 457 047 A1 the problem has been identified that when a single main nozzle is provided, the majority of the radially inflowing and filtered main nozzle air flow, denoted at that point by reference numeral 24, can be supplied to the ventilator impeller only in the outer edge area of the main nozzle. This is due to the fact that a portion of the main nozzle air flow passes by the fan impeller at high speed, resulting in undesirable turbulences, and for the same air volume, a higher energy demand and objectionable noise.

The object of the invention is to optimize the energy efficiency and the noise in a ventilation device, in particular an air purification device, having a low installation height.

The stated object is achieved in an air purification device with novel air guidance, comprising a housing, including at least one air intake region, formed in an inlet plenum, for drawing dirty air into the housing, and at least one air discharge region, formed in an outlet plenum (8), for discharging the filtered air from the housing, at least one fan impeller of a radial ventilator that is rotatable about a ventilator rotational axis and at least one air filter for filtering the air drawn in through the air intake region being situated in the housing, and the main nozzle air flow that is formed downstream from the air filter being deflected in the direction of the fan impeller at a main nozzle situated in the housing, upstream from the fan impeller, characterized in that for optimized flow onto the fan impeller of the radial ventilator and for the purpose of homogenizing the air volume in the air-guiding inflow plane of the radial ventilator, a separation of the main nozzle air flow by an auxiliary nozzle that is situated upstream from the main nozzle and that splits the main nozzle air flow takes place, and the auxiliary nozzle supplies an auxiliary nozzle air flow, split off from the main nozzle air flow, into the inner intake region of the fan impeller.

One preferred design provides that for optimized flow onto the fan impeller of the radial ventilator and for the purpose of homogenizing the air volume in the air-guiding inflow plane of the radial ventilator, a radial and axial separation of the main nozzle air flow by an auxiliary nozzle that is situated upstream from the main nozzle and that splits the main nozzle air flow takes place, and the auxiliary nozzle supplies an auxiliary nozzle air flow, split off from the main nozzle air flow, into the inner intake region of the fan impeller.

In this preferred design, it is thus provided that air flows from the main nozzle air flow onto the auxiliary nozzle situated upstream from the main nozzle in the radial direction, and the auxiliary nozzle is centered coaxially with respect to the main nozzle.

The invention is relevant for all ventilation devices or air purifiers in which a radial ventilator is connected to a radial inlet plenum. The invention allows reduction of the energy demand and noise, with a particularly low installation height, for devices having radial air intake. The radial air intake has the advantage that the front of the device is closed, and may thus have an attractive appearance without soiling.

The preferred features of the invention are stated below in summary form:
air purifier/ventilator with or without air humidification, heating, drying, or cooling
radial flow onto a forwardly or backwardly curved radial ventilator
180 to 360 degrees of radial flow onto the radial ventilator
the dual nozzle according to the invention or the inflow nozzle provided in a plurality results in optimized flow onto the radial ventilator in the axial direction
radial air guidance ribs (with profiling/curvature as a preferred design) result in optimized incident flow in the radial direction due to their precurvature
the radial supply of air into the device results in the following air-guiding components arranged in succession: an air inlet grill (air guidance ring provided with lamellae and air passage slits), an optional prefilter, an air filter, radial air guidance ribs in the inlet plenum, an inflow nozzle in a plurality (preferably made up of a main nozzle and auxiliary nozzle), a radial ventilator, an air outlet volute (forwardly curved radial ventilator), and an air outlet region.

This results in optimized flow onto the radial ventilator by radial and axial guiding or separation of the air flows of the filtered main nozzle air flow.

The second intake nozzle according to the invention, referred to as the auxiliary nozzle, acts on the main nozzle air flow as a split nozzle, and results in axial leading and guiding of a portion of the main nozzle air flow into the inner diameter area of the ventilator, and thus results in homogenization of the air volume in the inflow plane of the fan impeller.

The inflow turbulence is thus reduced, and the split main nozzle air flow is supplied more quickly and with less turbulence to the radial ventilator. The objective of energy- and noise-optimized air throughput and/or a reduction in the energy demand and the noise is achieved in this way.

The combination of radial air guidance ribs and at least one additional auxiliary nozzle thus ensures an optimized flow onto the radial ventilator. The load on the fan impeller due to dividing the air flow is improved in this way. Inflow of an excessive amount of air at the outer edge of the fan impeller is prevented. This ensures improved air distribution toward the axis of the fan impeller, since the air flow is distributed from the outer edge to the core of the fan impeller.

The surface area ratio of the outflow surface area of the auxiliary nozzle is ideally similar to that of the outflow surface area of the main nozzle. This results in improved overall energy efficiency of the air purification device, due to the fact that the air guidance ribs ensure a dual function as air guidance of the main nozzle air flow and also as a fan guard.

Preferred dimensions of the individual parts are stated below, which, however, are to be understood only as preferred dimensions. It is self-evident that these dimensions may also be modified. In particular, the stated dimensions and proportions may be analogously scaled to smaller or larger devices.

### Preferred but not Limiting Dimensions

Total height of air inlet plenum: 700 mm
Height of air guidance ribs: 700 mm
Diameter of radial ventilator: 280 mm
Inlet diameter of auxiliary nozzle: 280 mm
Outlet diameter of auxiliary nozzle: 195 mm
Height of auxiliary nozzle: 52 mm
Inlet diameter of main nozzle: 280 mm
Outlet diameter of main nozzle: 260 mm
Height of main nozzle: 15 mm.

### Proportions

Height of air guidance ribs relative to height of inlet plenum: 40-100%
Spacing between the air guidance ribs: 20-120% of the rib height
Inlet diameter of auxiliary nozzle: 80-120% of the ventilator diameter
Outlet diameter of auxiliary nozzle: 60-80% of the ventilator diameter
Height of auxiliary nozzle: 50-80% of the height of the inlet plenum
Auxiliary nozzle inlet surface area: 80% to 120% of the net main nozzle inlet surface area
Auxiliary nozzle outlet surface area: 80% to 120% of the net main nozzle outlet surface area

It is particularly advantageous that the main nozzle air flow, by means of air guidance ribs situated in the inlet plenum and fixed to the housing, is deflected approximately tangentially at the outer circumference of the auxiliary nozzle and of the main nozzle situated coaxially with respect to same.

It is preferred when the auxiliary nozzle is ring-shaped, and has an inlet surface area with an increased diameter, and which via an axial arched area that reduces the diameter in a nozzle-like manner merges into an outlet surface area with a decreased diameter.

Thus, this auxiliary nozzle acts as a pitot static tube or as a jet nozzle which is radially impinged on by the main nozzle air flow at the outer circumference which is split at the inlet edge of the auxiliary nozzle, one portion of the flow passing through at the arch-shaped, conically narrowing outer circumference of the auxiliary nozzle, and the other portion of the flow passing through at the inner circumference of the auxiliary nozzle at a higher speed in the direction of the main nozzle, so that the split main nozzle air flow is uniformly distributed over the entire effective cross section of the fan impeller. The conical narrowing of the auxiliary nozzle results in a jet effect (accelerated air flow) at the outlet surface area of the auxiliary nozzle, which is directed onto the middle and/or inner region of the fan impeller.

Further features are the subject matter of the remaining subclaims.

The subject matter of the present invention results not only from the subject matter of the individual claims, but also from the combination of the individual claims with one another.

All information and features disclosed in the application documents, including the abstract, in particular the spatial design illustrated in the drawings, may be claimed as essential to the invention, provided that, alone or in combination, they are novel with respect to the prior art. Use of the terms “essential” or “according to the invention” or “essential to the invention” is subjective, and does not imply that the features thus designated must necessarily be a component of one or more claims.

The invention is explained in greater detail below with reference to drawings that illustrate only one implementation approach. In this regard, further features and advantages of the invention that are essential to the invention emerge from the drawings and their description.

In the figures:

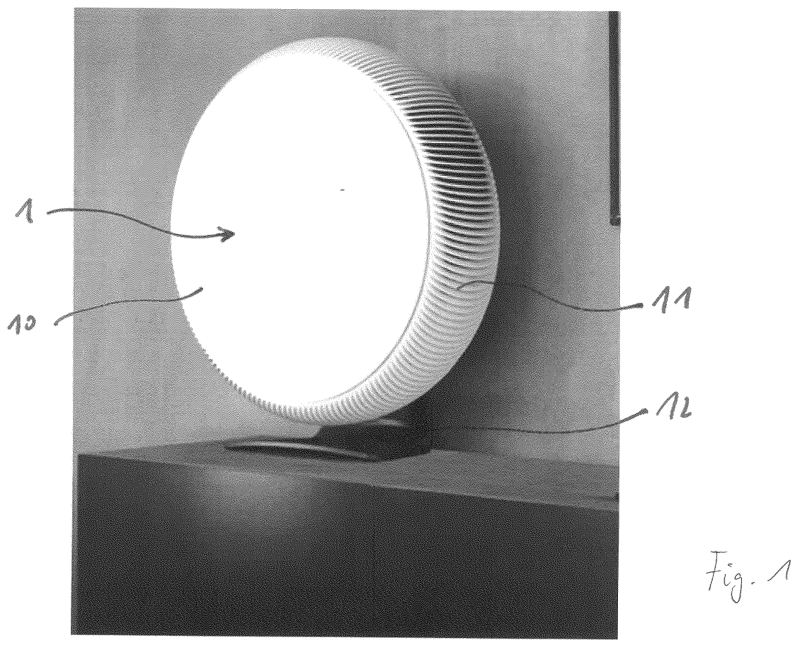

FIG. 1: shows a perspective illustration of an air purification device, which for illustrating the proportions is placed on a sideboard;

FIG. 2: shows an exploded illustration of the individual parts of the air purification device;

FIG. 3: shows a cross section of the air purification device;

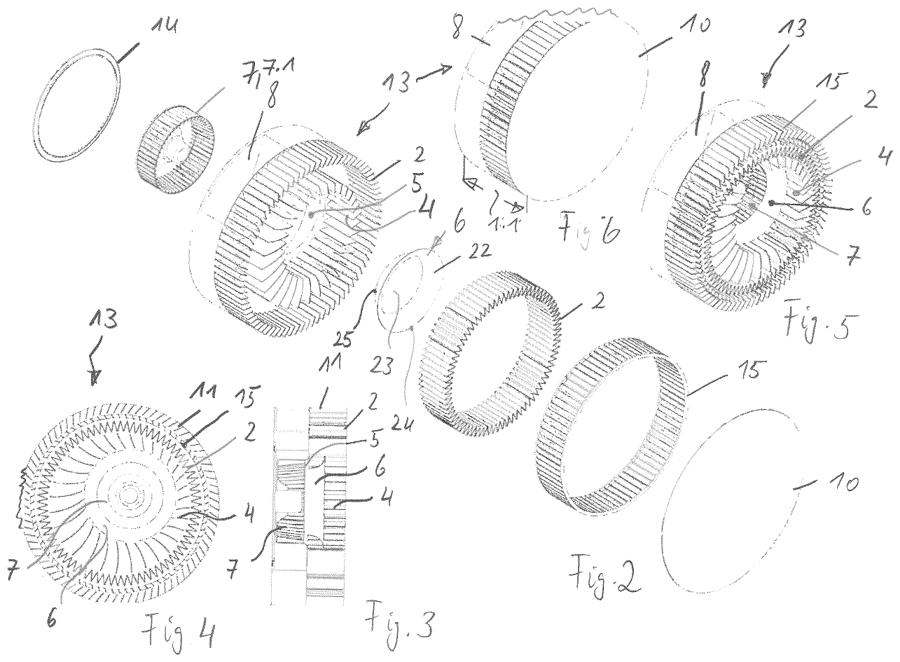

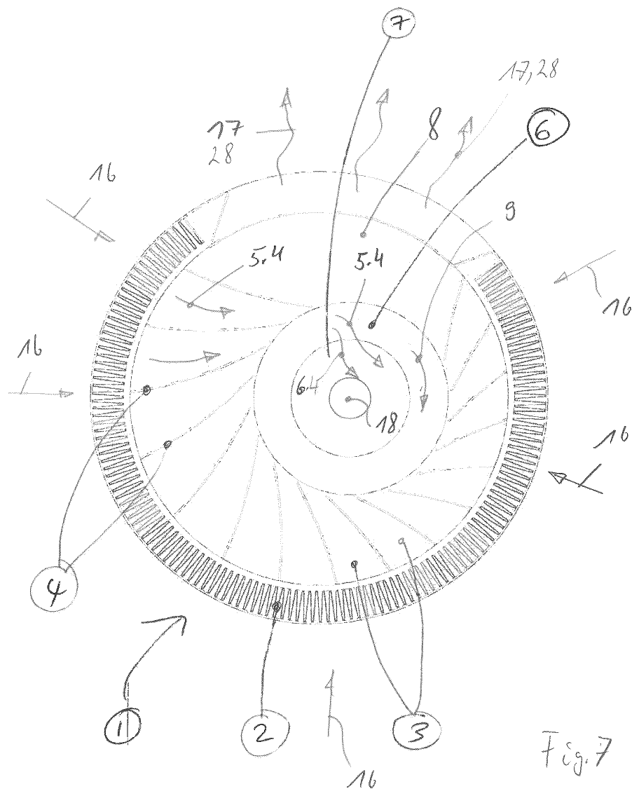

FIG. 4: shows a top view of the view according to FIG. 3;

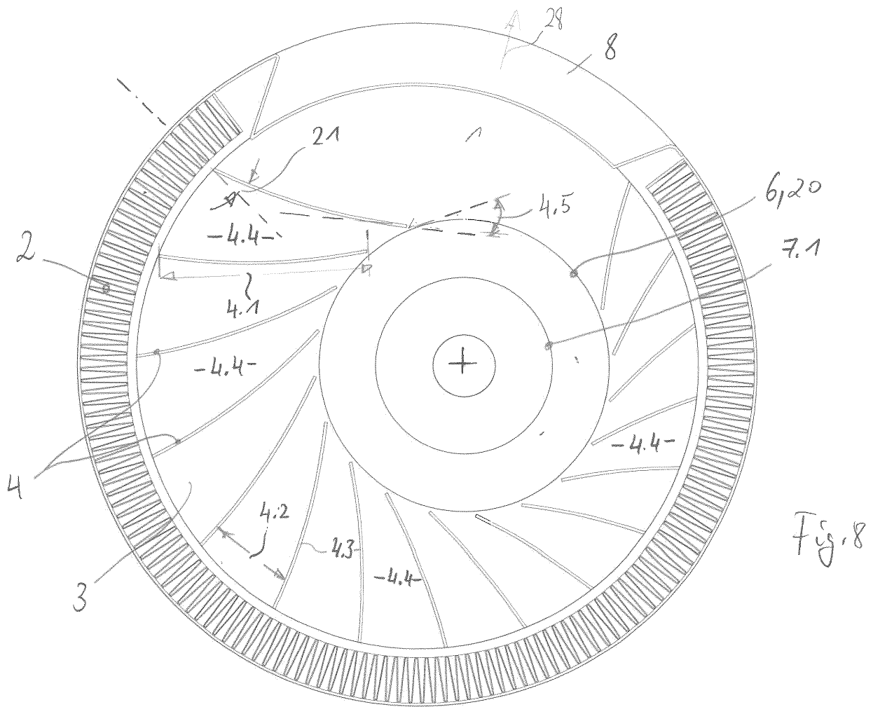

FIG. 5: shows a perspective illustration of the view according to FIG. 4;

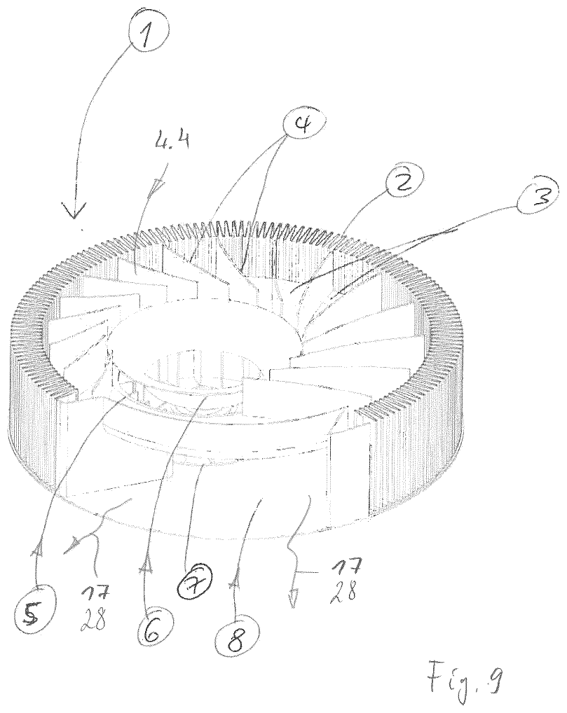

FIG. 6 shows the perspective illustration in the assembled state;

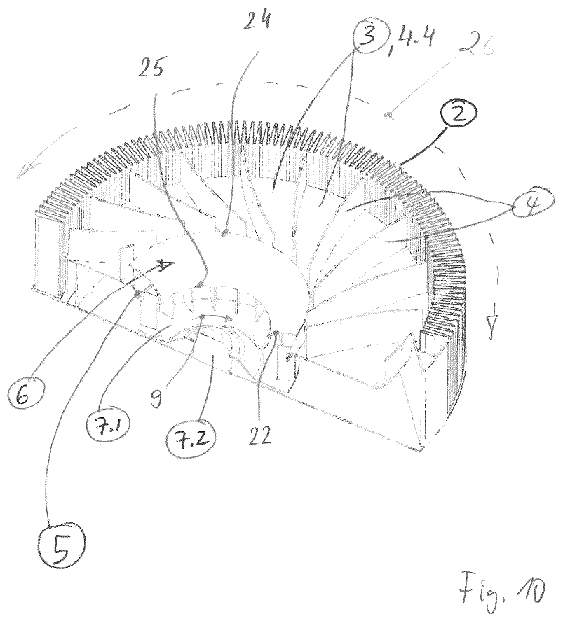

FIG. 7: shows a cross section of the air purification device;

FIG. 8: shows the same illustration as FIG. 7 with a depiction of further details;

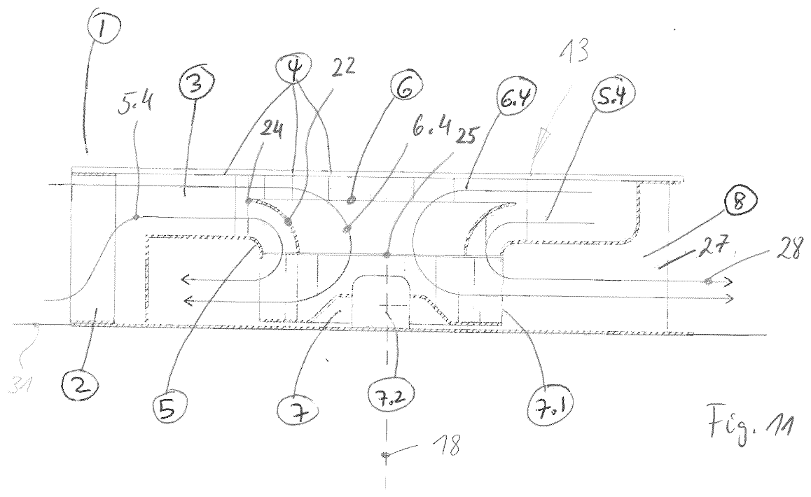

FIG. 9: shows a perspective illustration of a portion of the housing;

FIG. 10: shows a center cross section of the illustration according to FIG. 9;

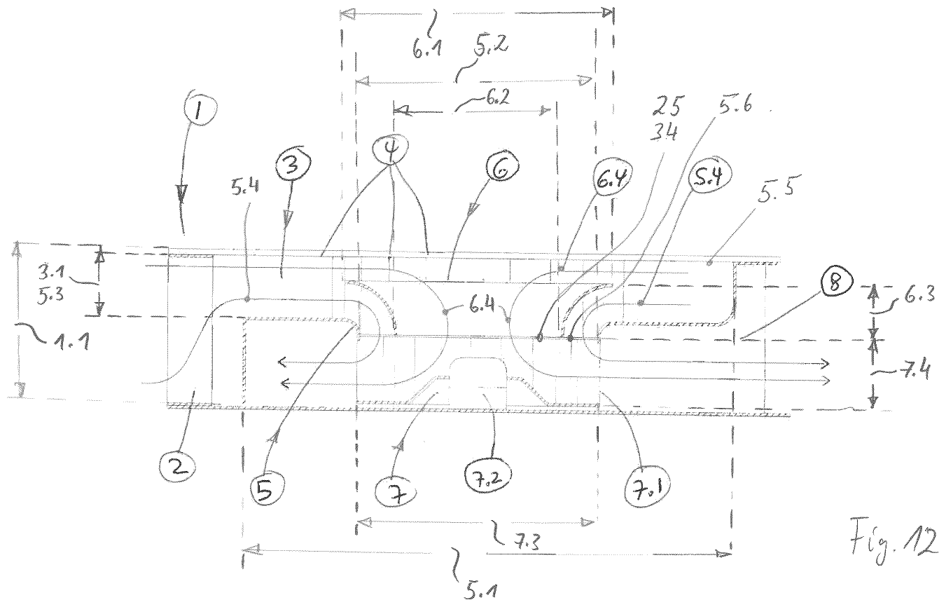

FIG. 11: shows a cross section of the illustration according to FIG. 10 with a depiction of the air flows;

FIG. 12: shows the same illustration as FIG. 11 with provision of further details; and

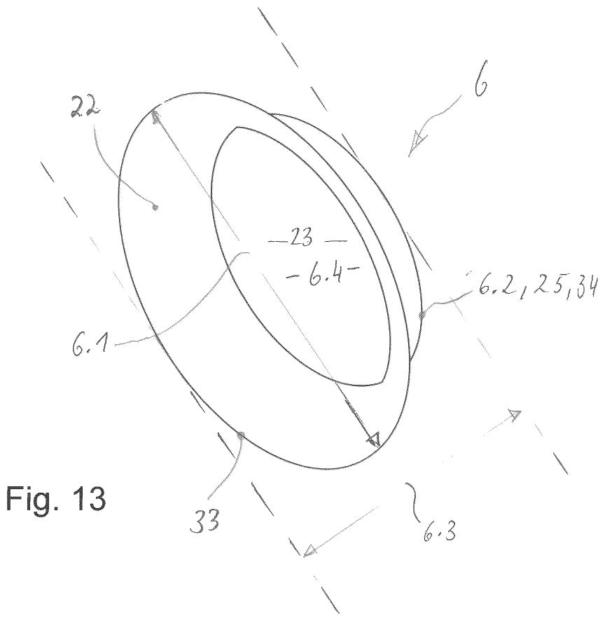

FIG. 13: shows the perspective illustration of the auxiliary nozzle.

With regard to the function, assembly, and operating principle of such an air purification device, reference is made to EP 3 457 047 A1. All features indicated therein are also used by the present invention, so that the disclosure of the cited publication is regarded as a disclosure of the present invention.

When reference is made to an air purification device 1 in the following description, this is not to be construed as limiting. The air purification device 1 may also be used as a simple ventilation device, which in this case then operates without filtering of the air. The term “air purification device” is used in the following description solely to make the description simpler.

Accordingly, FIG. 1 shows an air purification device 1 in a perspective illustration, which with its stand 12 rests on a sideboard, with the front side covered by an airtight cover plate 10 that makes a particularly decorative appearance possible. The air discharge region and the air intake region are covered by a ventilation grill 11 that encloses the outer circumference, the lamellae of the ventilation grill 11 exerting an additional, angled air guidance in the direction of the air filter 2 situated radially behind same.

FIG. 2 shows an exploded illustration of the association of the individual parts of the air purification device 1 with one another. The housing preferably has a disk shape or toroidal shape, corresponding to the shape of a discus used in athletics, and has a total installation height 1.1 that is low compared to the diameter.

The filter housing 13 is made up essentially of a disk- or discus-shaped plastic part, in the rear area of which an outlet plenum 8, outwardly directed in the radial direction, for blowing out the filtered air into the room is provided. The discharge opening formed by the outlet plenum 8 may be closed by an air-permeable lamella grill whose lamellae allow the discharge direction to be adjusted.

Illustrated only in FIG. 1 is a ventilation grill 11 on the inlet side, with its air-guiding lamellae which guide an angled air flow onto the outer circumference of the air filter 2.

Formed in the interior of the housing 13 is an inlet plenum 3 with air guidance ribs 4 situated therein which guide the inflowing and filtered main nozzle air flow 5.4 from the air filter 2 into the interior of the housing 13 in the direction of a main nozzle 5, and an auxiliary nozzle 6 oriented coaxially with respect to same.

FIG. 2 also illustrates that an air guidance ring 15 situated directly behind the ventilation grill 11 may be provided. It may also be provided that the air guidance ring 15 is omitted, and instead, the ventilation grill 11 with its air-guiding lamellae exerts the angled air guidance in the direction of the air filter 2.

In the cross section according to FIG. 3, it is apparent that the auxiliary nozzle 6 according to the invention is situated coaxially and concentrically with respect to the main nozzle 5. The fan impeller 7.1 of a radial ventilator 7, which is driven by a motor 7.2, is situated downstream from the main nozzle 5 and the auxiliary nozzle 6 oriented coaxially with respect to same. The fastening takes place via a fastening ring 14.

The air that is compressed and filtered by the fan impeller 7.1 of the radial ventilator 7 is discharged from an outlet plenum 8 as air flow 17, which is preferably directed radially outwardly.

FIG. 7 shows that the air flow 16 that acts on the outer circumference of the air filter 2 passes through the folds of the air filter 2, and subsequently passes into the radially outer area of angled, arch-shaped air guidance ribs 4 in the inlet plenum 3.

The main nozzle air flow 5.4 in the inlet plenum 3 is thus compressed, and at the same time is guided in a distributed manner in approximately the tangential direction over the outer circumference of the main nozzle 5 and the auxiliary nozzle 6 situated coaxially with respect to same.

The height of the inlet plenum 3 preferably corresponds to 15-40% of the diameter of the fan impeller 7.1.

FIG. 8 shows the arched contour of the ventilation ribs 4, which have a preferred length 4.1, a preferred spacing 4.2, and a preferred number 4.3, the preferred dimensions of which are stated in the subclaims. The ventilation ribs in each case thus form conically narrowing compression spaces 4.4, which lead the main nozzle air flow 5.4, thus compressed, at an essentially tangential angle 4.5 and in the radial direction to the outer circumference of the main nozzle and auxiliary nozzle.

FIG. 7 shows the effect of the auxiliary nozzle 6 on the main nozzle air flow 5.4, part of which is guided at the outer circumference of the fan impeller 7.1 of the radial ventilator 7, and the other part of which is directed, as an auxiliary nozzle air flow 6.4, onto the middle area and/or inner circumference of the fan impeller 7.1. It is preferred when the main air flow 5.4 in the inlet plenum 3 is deflected at an angle in the range of 180 to 360 degrees in the direction of the fan impeller 7.1 of the radial ventilator 7, and is thereby split by the auxiliary nozzle 6 according to the invention.

Therefore, various deflection angles of the main air flow 5.4 are illustrated in the drawings.

FIGS. 2, 3, 4, 5, and 6 illustrate a radial incident flow of 360 degrees, while FIGS. 7, 8, 9, 10, 11, and 12 illustrate a radial incident flow of the radial ventilator 7 of 270 degrees.

This results in homogenization of the air volume supplied to the fan impeller 7.1. The fan impeller 7.1 has a rotational axis 18.

It is apparent from FIG. 7 that the air flow 17 passing from the outlet plenum 8 forms the discharge air flow 28 directed in the radial direction.

FIG. 8 shows further details of the design according to FIG. 7. It is apparent that the flow passing through the air filter 2 reaches the area of the air guidance ribs 4 bent in a curve, which in an air-guiding manner adjoin the air filter 2 at an angle 21 and form conically narrowing compression spaces 4.4. The outlet of the particular compression space 4.4 adjoins the outer circumference of the main nozzle 5 and the auxiliary nozzle 6 at an approximately tangential angle 4.5. The preferred parameters, such as length 4.1, spacing 4.2, number 4.3, angle 4.5, and height 4.6 of the air guidance ribs 4 are the subject matter of the subclaims.

It is apparent from FIGS. 9 and 10 in conjunction with FIGS. 11 and 12 that the main nozzle air flow 5.4 that is directed onto the main nozzle 5 in the radial direction flows in the inlet plenum 3. The main nozzle air flow 5.4 is thus initially deflected, preferably by 180°, at a curved edge of the main nozzle 5 in the area of the inlet diameter 5.1. The auxiliary nozzle 6 according to the invention is situated coaxially with respect to the opening in the main nozzle 5 and upstream from the main nozzle 5 having an inlet diameter 6.1 and an outlet diameter 6.2. The height of the auxiliary nozzle is denoted by reference numeral 6.3.

Analogously, the main nozzle 5 forms an inlet diameter 5.1 and an outlet diameter 5.2 with a height 5.3. The main nozzle inlet surface area is denoted by reference numeral 5.5, and its outlet surface area is denoted by reference numeral 5.6.

It is apparent from FIG. 11 that the main nozzle air flow 5.4, upstream from the fan impeller 7.1, and its diameter 7.3 are split due to the coaxial arrangement of the main nozzle 5 and the auxiliary nozzle 6. The height of the radial ventilator is denoted by reference numeral 7.4.

Thus, the main nozzle air flow 5.4 at the inner side of the arched area 22 of the auxiliary nozzle 6 is divided into an inner auxiliary nozzle air flow 6.4, and the remainder of the main nozzle air flow passes by at the outer side of the arched area 22 of the auxiliary nozzle 6 and is deflected at the curved edge of the main nozzle 5.

Thus, for the first time, a concentrated supply of an auxiliary nozzle air flow 6.4 also passes into the middle region of the fan impeller 7.1, which thus far has not been possible.

FIG. 12 shows the proportions and dimensions of the individual parts relative to one another, using the same parts as in FIG. 11. The diameter of the inlet edge 24 of the auxiliary nozzle 6 is thus larger than the diameter of the outlet edge 25 of the auxiliary nozzle 6. The outer circumference of the auxiliary nozzle is denoted by reference numeral 20.

The auxiliary nozzle 6 thus forms a passage opening 23, which acts a jet nozzle, for the auxiliary nozzle flow 6.4, which as an air flow with increased speed is guided onto the inner region of the fan impeller 7.1.

FIG. 13 shows several features of the auxiliary nozzle 6. The inlet-side inlet surface area 33 and the reduced-diameter outlet surface area 34 situated downstream are shown. The height of the auxiliary nozzle is denoted by reference numeral 6.3, and the conically narrowing passage opening is denoted by reference numeral 23.

The radial plane of the housing 13 is denoted by reference numeral 31, while the discharge direction is denoted by reference numeral 30 and the direction of drawn-in air is denoted by reference numeral 29. The air outlet region as a whole is denoted by reference numeral 27.

The preferred dimensions and proportions are stated below: It is preferred for the auxiliary nozzle 6 to have a ring shape and an inlet surface area 33 with increased diameter 6.1, and which via an axial arched area 22 that reduces the diameter 6.1 in a nozzle-like manner merges into an outlet surface area 34 with a decreased diameter 6.2.

It is preferred for the outlet diameter 6.2 of the auxiliary nozzle 6 to be in the range between 60 and 80% smaller than the diameter 7.3 of the fan impeller 7.1.

It is preferred for the inlet diameter 6.1 of the auxiliary nozzle 6 to be in the range between 80 and 120% of the diameter 7.3 of the fan impeller 7.1.

It is preferred for the height 6.3 of the auxiliary nozzle 6 to correspond approximately to 50 to 80% of the height 3.1 of the inlet plenum 3.

It is preferred for the inlet surface area 33 of the auxiliary nozzle 6 to correspond approximately to 80 to 120% of the main nozzle inlet surface area 5.5.

It is preferred for the outlet surface area 34 of the auxiliary nozzle 6 to correspond approximately to 80 to 120% of the main nozzle outlet surface area 5.6.

It is preferred for the ratio of the air guidance ribs 4 to the height of the inlet plenum 3 to be in the range between 40 and 100%.

It is preferred for the spacing 4.2 of the air guidance ribs 4 relative to one another to be in the range between 20 and 120% of the rib height 4.6.

It is preferred for the housing 13 to have a disk- or toroid-shaped design, and for the air intake region 26 and the air discharge region 27 to be situated at the outer circumference of the housing 13.

It is preferred for the total height 3.1 of the inlet plenum 3 and the height 4.6 of the air guidance ribs to be approximately 700 mm.

It is preferred for the diameter 7.3 of the fan impeller 7.1 of the radial ventilator 7 and the inlet diameter 6.1 of the auxiliary nozzle 6 to be approximately 280 mm.

It is preferred for the outlet diameter 6.2 of the auxiliary nozzle 6 to be approximately 195 mm with a preferred height 6.3 of 52 mm.

It is preferred for the inlet diameter 5.1 of the main nozzle 5 to be preferably 280 mm, and the outlet diameter 5.2 of the main nozzle 5 to be preferably 260 mm, and the height 5.3 of the main nozzle 5 to be preferably 15 mm.

### LIST OF REFERENCE NUMERALS

1 air purification device or ventilation device
1.1 total installation height of the air purification device
2 air filter
3 inlet plenum
3.1 height of inlet plenum (15%-35% of the ventilator diameter)
4 air guidance ribs
4.1 length
4.2 spacing
4.3 number
4.4 compression space
4.5 angle
4.6 height
5 main nozzle
5.1 inlet diameter of main nozzle
5.2 outlet diameter of main nozzle
5.3 height of main nozzle
5.4 main nozzle air flow
5.5 main nozzle inlet surface area
5.6 main nozzle outlet surface area
6 auxiliary nozzle
6.1 inlet diameter of auxiliary nozzle
6.2 outlet diameter of auxiliary nozzle (60-80% of the ventilator diameter)
6.3 height of auxiliary nozzle
6.4 auxiliary nozzle air flow
7 radial ventilator
7.1 fan impeller
7.2 motor
7.3 diameter of radial ventilator
7.4 height of radial ventilator
8 outlet plenum
9 arrow direction 10 cover plate
11 ventilation grill
12 stand
13 filter housing
14 fastening ring
15 air guidance ring
16 air flow (inlet)
17 air flow (outlet)
18 rotational axis (of 7.1)
19 tangential angle (of 4.5)
20 outer circumference (of 6)
21 angle (of 4)
22 arched area (of 6)
23 passage opening (of 6)
24 inlet edge (of 6)
25 outlet edge (of 6)
26 air intake region
27 air discharge region
28 discharge air flow
29 direction (intake direction)
30 direction (discharge direction)
31 radial plane (housing 13)
32
33 inlet surface area (of 6)
34 outlet surface area (of 6)

1. An air purification device with novel air guidance, comprising a housing, including at least one air intake region, formed in an inlet plenum, for drawing dirty air into the housing, and at least one air discharge region, formed in an outlet plenum (8), for discharging the filtered air from the housing, at least one fan impeller of a radial ventilator that is rotatable about a ventilator rotational axis and at least one air filter for filtering the air drawn in through the air intake region being situated in the housing, and the main nozzle air flow that is formed downstream from the air filter being deflected in the direction of the fan impeller at a main nozzle situated in the housing, upstream from the fan impeller, characterized in that for optimized flow onto the fan impeller of the radial ventilator and for the purpose of homogenizing the air volume in the air-guiding inflow plane of the radial ventilator, a separation of the main nozzle air flow by an auxiliary nozzle that is situated upstream from the main nozzle and that splits the main nozzle air flow takes place, and the auxiliary nozzle supplies an auxiliary nozzle air flow, split off from the main nozzle air flow, into the inner intake region of the fan impeller.

2. The air purification device according to claim 1, wherein air flows from the main nozzle air flow onto the auxiliary nozzle situated upstream from the main nozzle in the radial direction, and the auxiliary nozzle is centered coaxially and concentrically with respect to the main nozzle.

3. The air purification device according claim 1, wherein the main nozzle air flow, by means of air guidance ribs situated in the inlet plenum and fixed to the housing, is deflected approximately tangentially at the outer circumference of the auxiliary nozzle.

4. The air purification device according to claim 1, wherein the auxiliary nozzle is ring-shaped, and has an inlet surface area with an increased diameter, and which via an axial arched area that reduces the diameter in a nozzle-like manner merges into an outlet surface area with a decreased diameter.

5. The air purification device according to claim 4, wherein the outlet diameter of the auxiliary nozzle (6) is in the range between 60 and 80% smaller than the diameter of the fan impeller.

6. The air purification device according to claim 4, wherein the inlet diameter of the auxiliary nozzle is in the range between 80 and 120% of the diameter of the fan impeller.

7. The air purification device according to claim 4, wherein the height of the auxiliary nozzle corresponds approximately to 50 to 80% of the height of the inlet plenum.

8. The air purification device according claim 4, wherein the inlet surface area of the auxiliary nozzle corresponds approximately to 80 to 120% of the main nozzle inlet surface area.

9. The air purification device according to claim 4, wherein the outlet surface area of the auxiliary nozzle corresponds approximately to 80 to 120% of the main nozzle outlet surface area.

10. The air purification device according claim 1, wherein the ratio of the air guidance ribs to the height of the inlet plenum is in the range between 40 and 100%.

11. The air purification device according to claim 1, wherein the spacing of the air guidance ribs relative to one another is in the range between 20 and 120% of the rib height.

12. The air purification device according to claim 1, wherein the housing has a disk- or toroid-shaped design, and the air intake region and the air discharge region are situated at the outer circumference of the housing.

13. The air purification device according to claim 1, wherein the total height of the inlet plenum and the height of the air guidance ribs are approximately 700 mm.

14. The air purification device according to claim 1, wherein the diameter of the fan impeller of the radial ventilator and the inlet diameter of the auxiliary nozzle (6) are approximately 280 mm.

15. The air purification device according to claim 1, wherein the outlet diameter of the auxiliary nozzle is approximately 195 mm with a preferred height of 52 mm.

16. The air purification device according to claim 1, wherein the inlet diameter of the main nozzle is preferably 280 mm and the outlet diameter of the auxiliary nozzle is preferably 260 mm, and the height of the main nozzle is preferably 15 mm.

17. The air purification device according claim 1, wherein the main air flow in the inlet plenum is deflected at an angle in the range of 180 to 360 degrees in the direction of the fan impeller of the radial ventilator.
